(19) United States
(12) Patent Application Publication
(10) Pub. No.: US 2016/0192679 A1
(43) Pub. Date: Jul. 7, 2016

(54) LIQUID DIETARY COMPOSITIONS FOR RUMINANTS AND METHODS OF MAKING AND USING THE SAME

(71) Applicant: BENEMILK OY, Raisio (FI)

(72) Inventors: Ilmo Pellervo ARONEN, Hinnerjoki (FI); Holma Birgitta HOLMA, Raisio (FI); Feng WAN, Issaquah, WA (US); Christopher John BUNTEL, Singapore (SG)

(73) Assignee: BENEMILK OY, Raisio (FI)

(21) Appl. No.: 14/909,106

(22) PCT Filed: Jul. 30, 2013
(86) PCT No.: PCT/US13/52623

§ 371 Date: Jan. 30, 2016

(51) Int. Cl. A23K 1/16

(52) U.S. Cl. CPC A23K 1/164; A23K 1/1603; A23K 1/1634; A23K 1/175; A23K 1/1631; A23K 1/1646; A23K 1/005

(57) ABSTRACT

Liquid dietary compositions for ruminants are disclosed, as well as methods for their preparation and use. The compositions may include a fatty acid component, at least one feed ingredient, and water. The fatty acid component may include less than about 10% by weight of unsaturated fatty acid. The feed ingredient may be selected from a carbohydrate, an amino acid, an amino acid derivative, a vitamin, a trace element, a mineral, a glucogenic precursor, or an antioxidant. The compositions may also include about 25% by weight to about 55% by weight of water.

### BACKGROUND

Increasing production and fat content of milk obtained from lactating ruminants has been a major goal for dairy farmers. Additional milk production per ruminant is beneficial because it results in a higher yield, thereby increasing profits. Increased milk fat is desirable because it has a higher economic value and can be used in highly desirable food products, such as cheese, yogurt, and the like.

A common approach to increasing either or both production and milk fat contents includes adjusting feed, nutrients, elements, vitamins, supplements, and/or the like provided to the ruminant. One such specific method includes feeding the ruminant a total mixed ration (TMR), which is a mix of grain and silage with some protein meals, such as, for example, soya bean meal and canola meal. Additional materials and trace elements, vitamins, extra nutrients, and the like may also be added to the TMR.

However, the current methods and feeds used to increase milk fat content tend to lower milk production, lower protein content, and/or have other detrimental effects on the ruminant. Furthermore, the methods and feeds oftentimes result in other undesired effects, such as increased trans fatty acid levels on the fatty acid profile of the milk fat.

### SUMMARY

In an embodiment, a liquid dietary composition for ruminants may include a fatty acid component, at least one feed ingredient, and water. The fatty acid component may include less than about 10% by weight of unsaturated fatty acid, and the at least one feed ingredient may be selected from a carbohydrate, a protein, an amino acid, an amino acid derivative, a vitamin, a trace element, a mineral, a glucogenic precursor, or an antioxidant. The liquid dietary composition may include about 25% to about 55% water by weight.

In an embodiment, a method of preparing a liquid dietary composition for ruminants may include combining a feed ingredient, water, and a fatty acid component to obtain the liquid dietary composition. The feed ingredient may include at least one of a carbohydrate, a protein, an amino acid, an amino acid derivative, a vitamin, a trace element, a mineral, a glucogenic precursor, and an antioxidant.

In an embodiment, a method of increasing milk fat content in ruminants may include providing a liquid dietary composition to a ruminant for ingestion. The liquid dietary composition may include a fatty acid component that includes at least about 90% by weight of a saturated fatty acid. The liquid dietary composition may also include at least one feed ingredient selected from a carbohydrate, a protein, an amino acid, an amino acid derivative, a vitamin, a trace element, a mineral, a glucogenic precursor, or an antioxidant. The liquid dietary composition may also include about 25% to about 55% water by weight.

In an embodiment, a liquid dietary composition for ruminants may include a fatty acid component, at least one feed ingredient, and water. The fatty acid component may have free palmitic acid in an amount of at least about 80% by weight of the fatty acid component and the feed ingredient may be selected from a carbohydrate, a protein, an amino acid, an amino acid derivative, a vitamin, a trace element, a mineral, a glucogenic precursor, or an antioxidant. The liquid dietary composition may include about 25% to about 55% water by weight.

### BRIEF DESCRIPTION OF THE DRAWINGS

FIG. 1 depicts a flow diagram of a method of preparing a dietary composition for ruminants according to an embodiment.

FIGS. 2A and 2B depict flow diagrams of alternative methods of preparing a dietary composition for ruminants according to various embodiments.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

The following terms shall have, for the purposes of this application, the respective meanings set forth below.

A “ruminant” is a class of mammal with a multiple chamber stomach that gives the animal an ability to digest cellulose-based food by softening it within a first chamber (rumen) of the stomach and regurgitating the semi-digested mass. The regurgitate, known as cud, is then chewed again by the ruminant. Specific examples of ruminants include, but are not limited to, cattle, bison, buffaloes, yaks, camels, llamas, giraffes, deer, pronghorns, antelopes, sheep, and goats. The milk produced by ruminants is widely used in a variety of dairy-based products. Dairy cows are of considerable commercial significance for the production of milk and processed dairy products such as, for example, yogurt, cheese, whey, and ice cream.

“Silage” refers to a feed that includes chopped green forage, such as, for example, grass, legumes, and field corn. The silage is placed in a structure or a container that is designed to exclude air. The silage is then fermented in the structure or container, thereby retarding spoilage. Silage can have a water content of about 60% to about 80% by weight.

The present disclosure relates generally to dietary compositions such as supplements and the like that can be fed to ruminants for purposes of affecting milk production in the ruminant. Particularly, the dietary compositions described herein may be fed to a ruminant to increase the amount of milk produced by the ruminant, and/or to increase the fat content of the milk produced by the ruminant, or both, as described in greater detail herein. Specific compositions described herein may be in liquid form, including liquid suspensions, emulsions, slurries, and/or the like, and may be used as liquid boosters for ruminants.

When a ruminant consumes feed, the fat in the feed is modified by the rumen to provide a milk fat profile that is different from the profile of fat in the feed. All fats which are not completely inert in the rumen may decrease rumen digestibility of the feed material. Milk composition and fat quality can be influenced by the ruminant's diet. For example, oil feeding can have negative effects on both rumen function and milk formation. As a result of the oil feeding, the milk protein concentration is lowered, the fat concentration is decreased, and the proportion of trans fatty acids is increased. These have been connected especially to an increase in the harmful low-density lipoprotein (LDL) cholesterol and to a decrease in the beneficial high-density lipoprotein (HDL) cholesterol in human blood when the milk is consumed. In addition, the properties of the milk fat during industrial milk processing are weakened. A high level of polyunsaturated fatty acids in milk can also cause taste defects and preservation problems. A typical fatty acid composition of milk fat may contain more than 70% saturated fatty acids and total amount of trans fatty acids may vary in the range of 3%-10%. When vegetable oil is added into the feed, the proportion of trans fatty acids may rise to more than 10%.

One solution to diminishing the detrimental effect of oil and fat is to prevent triglyceride fat hydrolysis. Fat hydrolysis can be decreased, for example, by protecting fats with formaldehyde treated casein. Another alternative is to make insoluble fatty acid calcium salts whereby hydrogenation in rumen can be avoided. However, fatty acid salts have a pungent taste, which can limit their usability in feeds and can result in decreased feed intake. The salts may also impact the pelletizing process of the feed.

Accordingly, the dietary composition described herein allows for the transfer of palmitic acid from the feed via the digestive tract into the blood circulation of a ruminant. This improves the energy efficiency of milk production of the ruminant. When the utilization of energy becomes more efficient, the milk production increases and the concentrations of protein or fat in the milk rise. Without being bound by the theory, the dietary composition may enhance fat synthesis in the mammary gland by bringing milk fat components to the cell and therefore the energy consuming synthesis in the mammary gland may not be necessary. Thus, glucose may be more efficiently be used for lactose production whereupon milk production increases. The milk protein content may rise since there may be no need to produce glucose from amino acids. Thus, the ruminant therefore may not lose weight at the beginning of the lactation period.

In the various embodiments described herein, the liquid compositions may include at least one fatty acid component, at least one feed ingredient, and water. The fatty acid component may be primarily saturated fatty acid (particularly palmitic acid) and may contain little or no unsaturated trans fatty acid, as described in greater detail herein. The fatty acid component may be about 30% to about 50% by weight of the liquid composition, the water about 25% to about 55% by weight of the liquid composition, and the feed ingredient about 9% to about 45% by weight of the liquid composition. In some embodiments, the liquid compositions described herein may be used as a booster for feed.

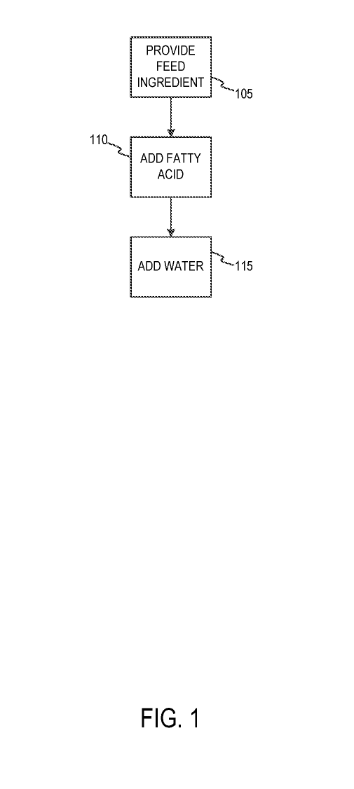

FIG. 1 depicts a flow diagram of a method of preparing a dietary composition for consumption by a ruminant. In various embodiments, the dietary composition may be formulated in a manner so that when consumed by the ruminant, the dietary composition maximizes particular qualities in the milk produced by the ruminant, an amount of milk produced by the ruminant, or both, as described in greater detail herein. In particular embodiments, the dietary composition may be substantially a liquid dietary composition, including, but not limited to, liquid suspensions, non-solids, slurries, emulsions, colloids, and the like.

In various embodiments, the components described herein with respect to FIG. 1 may generally be combined in any order and/or any combination, and are not limited by the order described herein. In some embodiments, a dietary composition may be prepared by providing 105 a feed ingredient, adding 110 a fatty acid to the feed ingredient, and adding 115 water to the feed ingredient and the fatty acid. Thus, processes 105, 110, and 115 result in combining the feed ingredient, the fatty acid, and water to obtain the dietary composition. Processes 105, 110, and 115 may be performed in different orders, or may all be performed simultaneously. Liquid dietary compositions as used herein may include liquids, non-solids, slurries, emulsions, colloids, liquid suspensions, and/or the like. Thus, in various embodiments, the composition may contain water in an amount of about 20% to about 80%, about 25% by weight to about 55%, from about 20% to about 50%, about 30% to about 60%, about 40% to about 70% of the dietary composition. In particular embodiments, the composition may contain about 20% water by weight, about 25% water by weight, about 30% water by weight, about 35% water by weight, about 40% water by weight, about 45% water by weight, about 50% water by weight, or any value or range between any two of these values. The amount of water present in the composition does not account for any water that may be present in the feed ingredient and/or the fatty acid component.

In various embodiments, the feed ingredient may be present in the dietary composition in an amount of from about 2% to about 70%, from about 5% to about 50%, from about 10% to about 60%, from about 20% to about 40% 45% by weight of the dietary composition. In particular embodiments, the feed ingredient may be present in the dietary composition in an amount of about 5% by weight, about 10% by weight, about 15% by weight, about 20% by weight, about 25% by weight, about 30% by weight, about 35% by weight, about 40% by weight, about 45% by weight, or any value or range between any two of these values.

In various embodiments, the feed ingredient may include a carbohydrate, a protein, an amino acid, an amino acid derivative, a vitamin, a trace element, a mineral, a glucogenic precursor, an antioxidant, and/or the like. The feed ingredient may include various portions generally included in particular amounts that are sufficient to provide beneficial nutritional and dietary needs of the ruminant that is to consume the dietary composition. For example, the feed ingredient may include a carbohydrate portion and a vitamin portion, each in an amount sufficient to provide beneficial nutritional and dietary needs of the ruminant.

The carbohydrate is not limited by this disclosure and may include any carbohydrates, particularly those used in animal feed. In some embodiments, the carbohydrate may generally provide a source of energy for the feed ingredient. Illustrative examples of carbohydrates may include molasses, sugar beet pulp, sugarcane, wheat bran, oat hulls, grain hulls, soybean hulls, peanut hulls, wood, brewery byproducts, beverage industry byproducts, forages, roughages, silages, molasses, sugars, starches, cellulose, hemicellulose, wheat, corn, oats, sorghum, millet, barley, barley fiber, barley hulls, barley middlings, barley bran, malting barley screenings, malting parley and fines, malt rootlets, maize bran, maize middlings, maize cobs, maize screenings, maize fiber, millet, rice, rice bran, rice middlings, rye, triticale, brewers grain, coffee grinds, tea leaf fines, citrus fruit pulp, rind residues, algae, algae meal, microalgae, and/or the like.

In various embodiments, the glucogenic precursor may include at least one of glycerol, propylene glycol, molasses, propionate, glycerine, propane diol, calcium propionate, propionic acid, octanoic acid, steam-exploded sawdust, steam-exploded wood chips, steam-exploded wheat straw, algae, algae meal, microalgae, or combinations thereof. The glucogenic precursor may generally be included in the feed ingredient to provide an energy source to the ruminant so as to prevent gluconeogenesis from occurring within the ruminant's body.

The antioxidant is not limited by this disclosure and may include any antioxidants or combination of antioxidants, particularly those used in animal feed and dietary compositions. Illustrative examples of antioxidants may include alpha-carotene. beta-carotene, ethoxyquin, butylated hydroxyanisole (BHA), butylated hydroxytoluene (BHT), cryptoxanthin, lutein, lycopene, zeaxanthin, vitamin A, vitamin C, vitamin E, selenium, alpha-lipoic acid, and/or the like.

In various embodiments, the vitamin may include any combination of vitamins, including, without limitation, vitamin A, vitamin B, vitamin C, vitamin D, vitamin E, vitamin K, and/or the like. Specific examples of vitamin B include thiamine (vitamin B₁), riboflavin (vitamin B₂), niacin (vitamin B₃), pantothenic acid (vitamin B₅), pyridoxine (vitamin B₆), biotin (vitamin B₇), folic acid (vitamin B₉), cobalamin (vitamin B₁₂), and choline (vitamin Bₚ).

In some embodiments, the feed ingredient may include an amount of carnitine. The carnitine may be included in the feed ingredient to aid in the breakdown of fatty acids to generate metabolic energy in the ruminant. In some embodiments, the carnitine may be present in a premix composition.

In various embodiments, the amino acid may include any combination of common, uncommon, essential, and non-essential amino acids, including, without limitation, leucine, lysine, histidine, valine, arginine, threonine, isoleucine, phenylalanine, methionine, tryptophan, and/or any derivative thereof. In some embodiments, the amino acid may be a non-essential amino acid, including any combination of alanine, asparagine, aspartate, cysteine, glutamate, glutamine, glycine, proline, serine, tyrosine, and/or any derivative thereof. The amino acid and/or any derivative thereof may also include amino acids and derivatives of both non-essential and essential amino acids. The amino acid may generally be included in the feed ingredient to provide a nutritional aid in various physiological processes in the ruminant, such as, for example, increasing muscle mass, providing energy, aiding in recovery, and/or the like. In some embodiments, the amino acid may be obtained from a premix composition.

In various embodiments, the mineral may be any mineral that is a generally recognized as safe (GRAS) mineral or a combination of such minerals. The mineral may further be obtained from any mineral source that provides a bioavailable mineral. In some embodiments, the mineral may be one or more of calcium, sodium, magnesium, potassium, phosphorous, zinc, selenium, manganese, iron, cobalt, copper, iodine, molybdenum, and/or the like. In some embodiments, the mineral may be selected from one or more of a sodium salt, a calcium salt, a magnesium salt, a cobalt salt, a manganese salt, a potassium salt, an iron salt, a zinc salt, copper sulfate, copper oxide, selenium yeast, a chelated mineral, and/or the like. Illustrative examples of sodium salts include monosodium phosphate, sodium acetate, sodium chloride, sodium bicarbonate, disodium phosphate, sodium iodate, sodium iodide, sodium tripolyphosphate, sodium sulfate, sodium selenite, and/or the like. Illustrative examples of calcium salts include calcium acetate, calcium carbonate, calcium chloride, calcium gluconate, calcium hydroxide, calcium iodate, calcium iodobehenate, calcium oxide, anhydrous calcium sulfate, calcium sulfate dehydrate, dicalcium phosphate, monocalcium phosphate, tricalcium phosphate, and/or the like. Illustrative magnesium salts include magnesium acetate, magnesium carbonate, magnesium oxide, magnesium sulfate, and/or the like. Illustrative cobalt salts include cobalt acetate, cobalt carbonate, cobalt chloride, cobalt oxide, cobalt sulfate, and/or the like. Illustrative examples of manganese salts include manganese carbonate, manganese chloride, manganese citrate, manganese gluconate, manganese orthophosphate, manganese oxide, manganese phosphate, manganese sulfate, and/or the like. Illustrative examples of potassium salts include potassium acetate, potassium bicarbonate, potassium carbonate, potassium chloride, potassium iodate, potassium iodide, potassium sulfate, and/or the like. Illustrative examples of iron salts include iron ammonium citrate, iron carbonate, iron chloride, iron gluconate, iron oxide, iron phosphate, iron pyrophosphate, iron sulfate, reduced iron, and/or the like. Illustrative examples of zinc salts include zinc acetate, zinc carbonate, zinc chloride, zinc oxide, zinc sulfate, and/or the like.

In some embodiments, the protein used in the feed ingredient may be obtained from a protein source. Illustrative examples of protein sources may include one or more grains and/or oilseed meals. The grain is generally not limited by this disclosure and may be any edible grain, or combination of grains, that is used as a protein source. Illustrative examples of grains include cereal grains such as barley, wheat, spelt wheat, rye, oats, triticale, rice, corn, buck wheat, quinoa, amaranthus, sorghum, and the like. Oilseed meal is generally derived from residue that remains after reserved oil is removed from oilseeds. The oilseed meal may be rich in protein and variable in residual fats and oils. Illustrative examples of oilseed meal includes rapeseed meal, soybean meal, sunflower meal, cottonseed meal, camelina meal, mustard seed meal, crambe seed meal, safflower meal, rice meal, peanut meal, corn gluten meal, corn gluten feed, distillers dried grains, distillers dried grains with solubles, wheat gluten, and/or the like.

In some embodiments, the feed ingredient may include at least one cellulosic material. The cellulosic material may generally provide a source of fiber for the ruminant to lower cholesterol levels and promote proper digestive function. Illustrative examples of cellulosic materials include wheat bran, wheat middlings, wheat mill run, oat hulls, oat bran, soya hulls, grass meal, hay meal, alfalfa meal, alfalfa, straw, hay, and/or the like.

In various embodiments, the feed ingredient may include a micronutrient mixture. Micronutrient mixtures are not limited by this disclosure and may generally contain any micronutrient mixture now known or later developed. The micronutrient mixture may include various components, such as at least one vitamin and at least one mineral, as described in greater detail herein. In some embodiments, the micronutrient mixture may be present in a premix composition.

In various embodiments, the fatty acid component may generally include one or more free fatty acids and/or glycolipids. Free fatty acids may generally be unconjugated fatty acids, whereas glycolipids may be fatty acids conjugated with a carbohydrate. In some embodiments, the fatty acid component may be present in the dietary composition in an amount of about 30% by weight to about 50% by weight of the dietary composition. In particular embodiments, the fatty acid component may be present in the dietary composition in an amount of about 30% by weight, about 35% by weight, about 40% by weight, about 45% by weight, about 50% by weight, or any value or range between any two of these values. In some embodiments, the fatty acid component may represent about 20% to about 50% by weight of the dietary composition.

In some embodiments, the fatty acid component may have a melting point equal to or greater than about 40° C. In some embodiments, the fatty acid component may have a melting point equal to or less than about 80° C. In some embodiments, the fatty acid component may have a melting point of about 40° C. to about 80° C. In particular embodiments, the fatty acid component may have a melting point of about 40° C., about 45° C., about 50° C., about 55° C., about 60° C., about 65° C., about 70° C., about 75° C., about 80° C., or any value or range between any two of these values. In some embodiments, emulsions made at or above the melting point of the fatty acid component may result in a more stable emulsion, as described in greater detail herein.

In various embodiments, the fatty acid component may include at least one saturated fatty acid. For example, the fatty acid component may include 1, 2, 3, 4, 5, 6, or more different saturated fatty acids. In some embodiments, the saturated fatty acid may be present in the fatty acid component in an amount that results in a ruminant consuming the dietary composition to produce a desired quality and/or quantity of milk, as described in greater detail herein. Thus, in some embodiments, the saturated fatty acid may be present in an amount of about 90% by weight of the fatty acid component to about 100% by weight of the fatty acid component, including about 90% by weight, about 91% by weight, about 92% by weight, about 93% by weight, about 94% by weight, about 95% by weight, about 96% by weight, about 97% by weight, about 98% by weight, about 99% by weight, about 100% by weight, or any value or range between any two of these values. The saturated fatty acid is not limited by this disclosure, and may include any number of saturated fatty acids now known or later discovered, including all derivatives thereof. For example, derivatives of a saturated fatty acid may include salts, esters, amides, carbonates, carbamates, imides, anhydrides, alcohols, and/or the like.

As used herein, the term “salt” of the fatty acid may be any acid addition salt, including, but not limited to, halogenic acid salts such as, for example, hydrobromic, hydrochloric, hydrofluoric, and hydroiodic acid salt; an inorganic acid salt such as, for example, nitric, perchloric, sulfuric, and phosphoric acid salt; an organic acid salt such as, for example, sulfonic acid salts (methanesulfonic, trifluoromethane sulfonic, ethanesulfonic, benzenesulfonic, or p-toluenesulfonic), acetic, malic, fumaric, succinic, citric, benzoic, gluconic, lactic, mandelic, mucic, pamoic, pantothenic, oxalic, and maleic acid salts; and an amino acid salt such as aspartic or glutamic acid salt. The acid addition salt may be a mono- or di-acid addition salt, such as a di-hydrohalogenic, di-sulfuric, di-phosphoric, or di-organic acid salt. In all cases, the acid addition salt is used as an achiral reagent which is not selected on the basis of any expected or known preference for interaction with or precipitation of a specific optical isomer of the products of this disclosure.

The term “fatty acid ester” as used herein means an ester of a fatty acid. For example, the fatty acid ester may be in a form of RCOOR′. R may be any saturated or unsaturated alkyl group including, without limitation, C10, C12, C14, C16, C18, C20, and C24. R′ may be any groups having from about 1 to about 1000 carbon atoms and with or without hetero atoms. In some embodiments, R′ may have from about 1 to about 20, from about 3 to about 10, and from about 5 to about 15 carbon atoms. The hetero atoms may include, without limitation, N, O, S, P, Se, halogen, Si, and B. For example, R′ may be a C₁₋₆alkyl, such as methyl, ethyl or t-butyl; a C₁₋₆alkoxyC₁₋₆alkyl; a heterocyclyl, such as tetrahydrofuranyl; a C₆₋₁₀aryloxyC₁₋₆alkyl, such as benzyloxymethyl (BOM); a silyl, such as trimethylsilyl, t-butyldimethylsilyl and t-butyldiphenylsilyl; a cinnamyl; an allyl; a C₁₋₆alkyl which is mono-, di- or trisubstituted by halogen, silyl, cyano or C₁₋₆aryl, wherein the aryl ring is unsubstituted or substituted by one, two or three, residues selected from the group consisting of C₁₋₇alkyl, C₁₋₇alkoxy, halogen, nitro, cyano and CF₃; or a C₁₋₂alkyl substituted by 9-fluorenyl.

As used herein, a “fatty acid amide” may generally include amides of fatty acids where the fatty acid is bonded to an amide group. For example, the fatty acid amide may have a formula of RCONR′R″. R may be any saturated or unsaturated alkyl group including, without limitation, C10, C12, C14, C16, C18, C20, and C24. R′ and R″ may be any group having from about 1 to about 1000 carbon atoms and with or without hetero atoms. In some embodiments, R′ may have from about 1 to about 20, from about 3 to about 10, and from about 5 to about 15 carbon atoms. The hetero atoms may include, without limitation, N, O, S, P, Se, halogen, Si, and B. For example, R′ and R″ each may be an alkyl, an alkenyl, an alkynyl, an aryl, an aralkyl, a cycloalkyl, a halogenated alkyl, or a heterocycloalkyl group.

A “fatty acid anhydride” may generally refer to a compound which results from the condensation of a fatty acid with a carboxylic acid. Illustrative examples of carboxylic acids that may be used to form a fatty acid anhydride include acetic acid, propionic acid, benzoic acid, and the like.

An “alcohol” of a fatty acid refers to a fatty acid having straight or branched, saturated, radical groups with 3-30 carbon atoms and one or more hydroxy groups. The alkyl portion of the alcohol component can be propyl, butyl, pentyl, hexyl, iso-propyl, iso-butyl, sec-butyl, tert-butyl, or the like. One of skill in the art may appreciate that other alcohol groups may also useful in the present disclosure.

In some embodiments, the saturated fatty acid may include a palmitic acid compound. The palmitic acid compound is not limited by this disclosure, and may include one or more of a conjugated palmitic acid, unconjugated palmitic acid, free palmitic acid, palmitic acid derivatives, and/or the like. Palmitic acid, also known as hexadecanoic acid, has a molecular formula of CH₃(CH₂)₁₄CO₂H. Specific examples of palmitic acid derivatives may include palmitic acid esters, palmitic acid amides, palmitic acid salts, palmitic acid carbonates, palmitic acid carbamates, palmitic acid imides, palmitic acid anhydrides, and/or the like. The palmitic acid compound may be present in the fatty acid component in an amount of about 60% by weight of the fatty acid to about 100% by weight of the fatty acid, including about 60% by weight, about 65% by weight, about 70% by weight, about 75% by weight, about 80% by weight, about 85% by weight, about 90% by weight, about 95% by weight, about 98% by weight, about 99% by weight, about 100% by weight, or any value or range between any two of these values. In some embodiments, the fatty acid component may consist essentially of the palmitic acid compound. In other embodiments, the fatty acid component may be entirely composed of the palmitic acid compound.

In some embodiments, the saturated fatty acid may include a stearic acid compound. The stearic acid compound is not limited by this disclosure, and may include conjugated stearic acid, unconjugated stearic acid, free stearic acid, stearic acid derivatives, and/or the like. Stearic acid, also known as octadecanoic acid, has a chemical formula of CH₃(CH₂)₁₆CO₂H. Specific examples of stearic acid derivatives may include stearic acid esters, stearic acid amides, stearic acid salts, stearic acid carbonates, stearic acid carbamates, stearic acid imides, stearic acid anhydrides, and/or the like. Because stearic acid in large amounts may hinder milk production capacity of the mammary gland, the amount of stearic acid may be present in the fatty acid component in an amount of about 30% or less by weight of the fatty acid component. In particular embodiments, the stearic acid compound may include about 30% by weight of the fatty acid component, about 25% by weight of the fatty acid component, about 20% by weight of the fatty acid component, about 15% by weight of the fatty acid component, about 10% by weight of the fatty acid component, about 5% by weight of the fatty acid component, or any value or range between any two of these values.

In some embodiments, the fatty acid component may include an unsaturated fatty acid. The term “unsaturated fatty acid” as used herein refers to any mono- and polyunsaturated fat, and includes unsaturated trans fatty acids. The unsaturated fatty acids must contain at least one alkene bond and may contain two or more alkene groups in any position in the hydrocarbon chain, and the unsaturation may or may not be present as a conjugated system of double bonds. The unsaturated fatty acid is not limited by this disclosure, and may include any number of unsaturated fatty acids now known or later discovered, including all derivatives thereof. For example, derivatives of an unsaturated fatty acid may include salts, esters, amides, anhydrides, alcohols, and/or the like, as previously described herein. In various embodiments, a minimal amount of unsaturated fatty acid in the fatty acid component to affect a desired quality of milk produced by the ruminant consuming the dietary composition may be used, as described in greater detail herein. Thus, in some embodiments, the fatty acid component may be substantially free of unsaturated fatty acids. As used herein with respect to unsaturated fatty acids, the term “substantially free” is understood to mean substantially no amount of unsaturated fatty acids or about 10% or less by weight of unsaturated fatty acids, including trace amounts of unsaturated fatty acids. Accordingly, the unsaturated fatty acid may be present in the fatty acid component in an amount of about 10% or less by weight of the fatty acid component, including about 10% or less by weight, about 5% or less by weight, about 4% or less by weight, about 3% or less by weight, about 2% or less by weight, about 1% or less by weight, about 0.5% or less by weight, about 0% by weight, or any value or range between any two of these values.

In various embodiments, at least a portion of the fatty acid component may be contained. In some embodiments, the fatty acid may be pre-contained prior to adding 110 the fatty acid to the feed ingredient. In other embodiments, the fatty acid may be contained as a result of the various processes 105, 110, 115 described herein. In some embodiments, the fatty acid may generally be contained by at least one supermolecular structure. Supermolecular structures may include vesicular structures such as microemulsions, liposomes (vesicles), micelles, and reverse micelles. The liposomes (vesicles) may contain an aqueous volume that is entirely enclosed by a membrane composed of lipid molecules, such as phospholipids. In some embodiments, the liposomes may have a bilayer membrane. In some embodiments, the liposomes may include at least one surfactant. Examples of surfactants may include polyoxyethylene ethers and esters of fatty acids. The surfactant may have an hydrophilic-lipophilic balance (HLB) value of about 2 to about 12, including about 2, about 3, about 4, about 5, about 6, about 7, about 8, about 9, about 10, about 11, about 12, or any range or value between any two of these values. Micelles and reverse micelles are microscopic vesicles that contain amphipathic constituents but do not contain an aqueous volume that is entirely enclosed by a membrane. In micelles, the hydrophilic part of the amphipathic compound is on the outside (on the surface of the vesicle). In reverse micelles, the hydrophobic part of the amphipathic compound is on the outside. The reverse micelles may thus contain a polar core that can solubilize both water and macromolecules within the inverse micelle. As the volume of the core aqueous pool increases, the aqueous environment begins to match the physical and chemical characteristics of bulk water. The resulting inverse micelle may be referred to as a microemulsion of water in oil.

In some embodiments, at least a portion of the fatty acid may be contained in a core of a micelle, liposome, or a vesicle. The core may include any number of particles therein in addition to the fatty acid. The core composition may be made of a core material that includes at least one of the protein material, the cellulosic material, the amino acid, and the amino acid derivative, as described in greater detail herein.

In various embodiments, at least a portion of the fatty acid component may be encapsulated. In some embodiments, the fatty acid may be pre-encapsulated prior to adding 110 the fatty acid to the feed ingredient. In other embodiments, the fatty acid may be encapsulated as a result of the various processes 105, 110, 115 described herein. In some embodiments, the fatty acid may generally be encapsulated by a capsule. The capsule may include a capsule shell, which is made up of polysaccharide or protein. Illustrative examples of capsule shells as described herein may include capsule shells including agar, gelatin, starch casein, chitosan, soya bean protein, safflower protein, alginates, gellan gum, carrageenan, xanthan gum, phtalated gelatin, succinated gelatin, cellulosephtalate-acetate, polyvinylacetate, hydroxypropyl methylcellulose, polyvinylacetate-phtalate, polymerisates of acrylic esters, polymerisates of methacrylic esters, and/or mixtures thereof

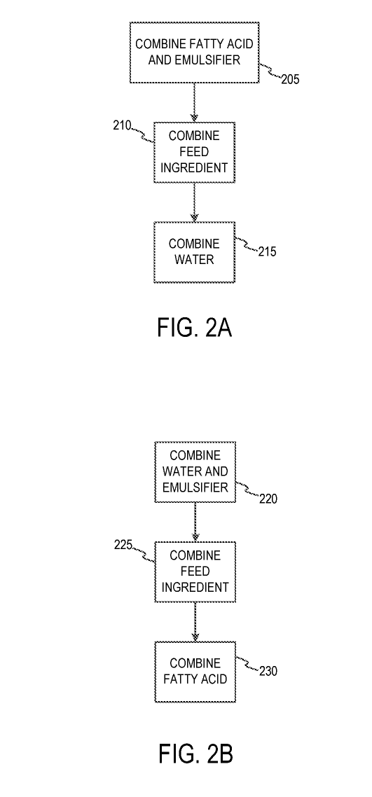

In various embodiments, an emulsifier may be combined with the feed ingredient, the fatty acid component and the water to form an emulsion, as depicted in FIGS. 2A and 2B. As depicted in FIG. 2A, the fatty acid may be combined 205 with the emulsifier to provide an emulsion. The combination 205 may include combining the fatty acid and the emulsifier under pressure. Suitable pressure may include about 1 atm to about 10 atm, including about 1 atm, about 2 atm, about 3 atm, about 4 atm, about 5 atm, about 6 atm, about 7 atm, about 8 atm, about 9 atm, about 10 atm, or any value or range between any two of these values. The emulsion may be combined 210 with the feed ingredient and combined 215 with the water to obtain the final product.

The emulsifier is not limited by this disclosure, and may generally be any composition that is capable of emulsifying the dietary composition. Specific examples of emulsifiers may include lecithin, natural seed weed, natural seed gums, natural plant exudates, natural fruit extracts, animal skin and bone extracts, bio-synthetic gums, starches, fibers, sucrose esters, Tween, polyglycerol esters, sugar esters, castor oil, and ethoxylated castor oil. Examples of natural seed weed may include carrageenan, alginates, agar, agarose, fucellan, and xanthan gum or a combination thereof. Examples of natural seed gums may include guar gum, locust bean gum, tara gum, tamarind gum, and psillium gum. Examples of natural plant exudates are gum Arabic, tragacanth, karaya, and ghatti. Natural fruit extracts are, for example, low and high methoxyl pectins. Animal skin and bone extracts are, for example, gelatin A, gelatin B, and hydrolyzed gelatin. Gum Arabic is a natural food additive obtained from certain varieties of acacia. It is generally tasteless and odorless, and may be used in commercial food processing to thicken, emulsify, and/or stabilize foods. Guar gum is a gummy substance obtained from plants of the legume genera. Guar gum may also be used as a thickener and/or a stabilizer in commercial food processing. Xanthan gum is produced by fermentation of corn sugar, and may be used as a thickener, an emulsifier, and/or a stabilizer of foods. In particular embodiments, gum Arabic, guar gum, xanthan gum, and/or pectin may be used in combination as an emulsion stabilizer. Illustrative examples of bio-synthetic gums may include xanthan, gellan, curdian, and pullulan. Examples of starches may include natural starch, chemically modified starch, physically modified starch, and enzymatically modified starch. Castor oil may be effective as an emulsifier because of its ability to render oil soluble in water.

In various embodiments, the emulsifier may have a hydrophilic-lipophilic balance HLB of about 5 to about 14. In particular embodiments, the HLB of the emulsifier may be about 5, about 6, about 7, about 8, about 9, about 10, about 11, about 12, about 13, about 14, or any value or range between any two of these values.

In various embodiments, the emulsifier may be present in the dietary composition in an amount of about 0.01% by weight to about 2.0% by weight of the dietary composition. In particular embodiments, the emulsifier may be present in the dietary composition in an amount of about 0.01% by weight, about 0.05% by weight, about 0.1% by weight, about 0.2% by weight, about 0.25% by weight, about 0.3% by weight, about 0.5% by weight, about 0.6% by weight, about 0.75% by weight, about 1.0% by weight, about 1.25% by weight, about 1.5% by weight, about 1.75% by weight, about 2.0% by weight, or any value or range between any two of these values.

In some embodiments, as depicted in FIG. 2B, the emulsifier may be combined 220 with water under pressure to provide an emulsion. In some embodiments, the pressure may be about 1 atm to about 10 atm. In particular embodiments, the pressure may be about 1 atm, about 2 atm, about 3 atm, about 4 atm, about 5 atm, about 6 atm, about 7 atm, about 8 atm, about 9 atm, about 10 atm, or any value or range between any two of these values. The emulsion may be combined 225 with the feed ingredient and combined 230 with the fatty acid to obtain the final product.

In various embodiments, a method of increasing milk fat content in ruminants may include providing the dietary composition as described herein to the ruminant for ingestion. In some embodiments, the dietary composition may be provided as a supplement or a booster. In particular embodiments, the dietary composition may be a liquid dietary composition, as described in greater detail herein. In some embodiments, the composition may be admixed with feed to be provided to the ruminant. In some embodiments, the composition may be coated on the feed to be provided to the ruminant. In some embodiments, the dietary composition may be provided to the ruminant in an amount that the ruminant receives at least about 10 grams of fatty acid per kilogram of milk produced by the ruminant each day. The amount may be based on the previous day's milk production by the ruminant, an average day based on the previous week's milk production by the ruminant, an average day based on the previous month's milk production by the ruminant, an average production of milk by the ruminant when not provided the dietary composition, and/or the like. In some embodiments, the ruminant may be provided with additional amounts of the dietary composition to make up for portions of the dietary composition that are not consumed by the ruminant such as amounts that are spilled by the ruminant when consuming the dietary composition and/or the like.

In some embodiments, providing the dietary composition to the ruminant for the ruminant to consume may result in an increase in production of milk and/or an increase in fat content of the milk produced. These increases may generally be relative to a similar ruminant that does not receive the dietary composition, an average of similar ruminants not receiving the dietary composition, an average of the milk production quantity and fat content of the same ruminant when not provided the dietary composition, and/or the like. In particular embodiments, the milk production may increase by an amount of about 1% to about 10%, including about 1%, about 2%, about 3%, about 4%, about 5%, about 6%, about 7%, about 8%, about 9%, about 10%, or any value or range between any two of these values. In particular embodiments, the milk fat content may increase by an amount of about 10% to about 15%, including about 10%, about 11%, about 12%, about 13%, about 14%, about 15%, or any value or range between any two of these values.

Various portions of the components described herein may be ground to a particular particle size. Grinding may be performed by various grinding devices known to those having ordinary skill in the art, such as a hammer mill, a roller mill, a disk mill, or the like. The various components described herein may be ground to various sizes, such as particle size (for instance, measured in millimeters), mesh sizes, surface areas, or the like. According to some embodiments, the components may be ground to an average particle size of about 0.05 mm to about 10 mm. More particularly, the various components may be ground to produce a granular material having an average particle size of about 0.05 mm, about 0.1 mm, about 0.2 mm, about 0.5 mm, about 1.0 mm, about 2.0 mm, about 3.0 mm, about 4.0 mm, about 5.0 mm, about 6.0 mm, about 7.0 mm, about 8.0 mm, about 9.0 mm, about 10.0 mm, or any value or range between any two of these values. In some embodiments, the various components may be ground so that about 20% to 50% of the each component and/or all components are retained by a mesh having openings with a size of about 10 mm and so that about 70% to about 90% of each component and/or all components are retained by a mesh having openings with a size of about 1 mm. In some embodiments, the various components may have a varying distribution of particle sizes based upon the ingredients. For example, in embodiments containing one or more wheat ingredients, the particle size may be distributed so that about 95% of the ground wheat ingredients are retained by a mesh having openings with a size of about 0.0625 mm and so that about 65% of the ground wheat ingredients are retained by a mesh having openings with a size of about 1.0 mm. In another example, such as embodiments containing one or more barley ingredients, the particle size may be distributed so that about 95% of the ground barley ingredients are retained by a mesh having openings with a size of about 0.0625 mm and so that about 60% of the ground barley ingredients are retained by a mesh having openings with a size of about 1.0 mm. The varying mesh sizes of each ingredient may be independent of mesh sizes for other ingredients.

### EXAMPLES

### Example 1

### Making a Liquid Composition

A liquid dietary composition to be used as a feed booster for ruminant feed is made using a process of combining a feed ingredient, a fatty acid, and water. The fatty acid component is combined in an amount that is about 50% by weight of the liquid dietary composition. The fatty acid component includes about 95% by weight of free palmitic acid, about 5% by weight of stearic acid and no unsaturated trans fatty acids. The liquid dietary composition also includes 5% by weight of a feed ingredient to include additional nutrients not currently present and/or lacking in the ruminant's current feed. The feed ingredient includes sugar beet pulp, glycerol, propane diol, vitamin A, riboflavin, biotin, folic acid, vitamin D, carnitine, a phenylalanine derivative, calcium, iron, oat hulls, hay meal, and straw. The liquid dietary composition also includes about 45% of water by weight.

### Example 2

### Feeding a Dairy Cow

A dairy cow that has a normal (untreated) average daily production of 30 kg milk is provided with a liquid dietary composition to increase the milk fat and the quantity of the milk produced. The liquid dietary composition is a liquid suspension that includes a fatty acid component that is about 35% by weight of the liquid dietary composition. The fatty acid component includes about 90% by weight of free palmitic acid, about 10% by weight of stearic acid and no unsaturated trans fatty acids. The liquid dietary composition also includes 15% by weight of a feed ingredient having at least molasses, vitamin A, riboflavin, vitamin E, carnitine, lysine, phenylalanine, calcium, sodium, selenium, iron, sunflower meal, peanut meal, wheat gluten, oat hulls, hay meal, and straw. The liquid dietary composition also includes about 50% of water by weight.

The dairy cow is given about 350 grams of the liquid dietary composition to drink in the morning to ensure that the cow consumes at least about 333 grams of the liquid dietary composition to ensure that she consumes 10 grams of free palmitic acid for every kilogram of milk that she produces that day. As a result, she produces 10% more milk than she did previously, and the milk that she produces contains 10% more milk fat content than the milk she produced previously.

### Example 3

### Providing to a Large Group of Cows

The liquid dietary composition as described above with respect to Example 2 is provided to a large group of cows on a commercial dairy farm to determine its effectiveness. 200 dairy cows from the commercial dairy farm are selected at random to provide a wide variety of variation in various characteristics, such as breed, weight, age of the cow, and the like. Each day, a first group of 100 cows is fed a standard TMR feed with the liquid dietary composition as a booster ad libitum. A control group of the remaining 100 cows is fed the standard TMR feed given to the first group of cows ad libitum, but without the liquid dietary composition as a booster. The 200 cows are monitored for the amount of feed and/or booster consumed, changes in weight, an amount of milk the cow produces each day, and the composition of the milk produced by the cow each day. Monitoring is continued for a period of 30 days. A comparison of the two groups of cows over this period of time shows a statistically significant improvement from the group that consumed the liquid booster over the control group that did not receive the liquid booster.

### Example 4

### Replacing Conventional Feed with New Composition

An experiment is performed where conventional complete feed is replaced with a liquid dietary composition according to the present disclosure. The experiment is continued for two months. The liquid dietary composition includes the following ingredients and amounts (in percent by total weight of the liquid dietary composition).

| | |
|---|---|
| Water | 30 |
| Sugar beet pulp | 10 |
| Barley | 10 |
| Palmitic Acid | 11 |
| Wheat bran | 7 |
| Oat bran | 5 |
| Propylene glycol | 5 |
| Molasses | 20 |
| Sodium bicarbonate | 1 |
| Biotin | 0.5 |
| Carnitine | 0.2 |
| Methionine | 0.25 |
| Emulsifier (non-ionic) | 0.05 |

The ingredients described above are mixed by placing the water in a container and adding the remaining ingredients substantially simultaneously. The mixture may be stirred to ensure the ingredients are well-blended. Upon feeding the test feed mixture to a cow, the following results are determined from the milk produced by the cow, where “Reference” refers to milk obtained from a similarly treated cow not fed the mixture.

| | Reference | Test Feed |
|---|---|---|
| Milk (kg/d) | 29.5 | 32.5 |
| Fat % by weight | 3.98 | 4.43 |

As shown in the results above, milk fat concentrations and the amount of milk produced increase significantly.

### Example 5

### Fatty Acid Composition

The following table describes a fatty acid composition that may be used to increase the volume of milk produced by a ruminant and the milk fat content of the milk produced by the ruminant.

| Fatty Acid | % of Fatty Acid Component (by weight) |
|---|---|
| Palmitic Acid | ≧90 |
| Stearic Acid | ≦10 |
| Unsaturated Trans-fatty Acid | 0 |
| Free Fatty Acids | Approx. 100 |

### Example 6

### Supplementing Conventional Feed

An experiment is performed where conventional complete feed is supplemented with a liquid dietary composition according to the present disclosure. The dietary composition has a fatty acid composition as described herein with respect to Example 3. The experiment is continued for two months. The liquid dietary composition includes the following ingredients and amounts (in percent by total weight of the liquid dietary composition).

| | |
|---|---|
| Water | 30 |
| Rapeseed meal | 15 |
| Barley | 15 |
| Wheat | 10 |
| Sugar beet pulp | 5.3 |
| Mixed molasses | 20 |
| Mineral mixture | 1 |
| Micronutrient mixture | 0.1 |
| Vitamin mixture | 0.1 |
| Emulsifier | 0.05 |
| Fatty Acid Component | 3.0 |

The fatty acid mixture and the emulsifier are mixed into the other materials to obtain 100% by weight of feed mixture. The feed mixture is mixed in a horizontal mixer for 3 minutes, and the emulsifier and fatty acid mixture are melted into the other materials in a long term conditioner for 20 minutes at a temperature of 77° C. in order to slowly melt and mix the materials together. Dairy cows are given the mixture in an amount of about 6-16 kg per day over the course of 2 months. The following positive results are expected, where “Reference” refers to milk obtained from a similarly treated cow not fed the liquid dietary composition:

| | Reference | Test Feed |
|---|---|---|
| Milk (kg/d) | 30.0 | 33.5 |
| Fat % by weight | 4.16 | 4.53 |

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases at least one and one or more to introduce claim recitations. However, the use of such phrases should not be construed to imply that the introduction of a claim recitation by the indefinite articles “a” or an limits any particular claim containing such introduced claim recitation to embodiments containing only one such recitation, even when the same claim includes the introductory phrases one or more or at least one and indefinite articles such as “a” or an (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera As a non-limiting example, each range discussed herein can be readily broken down into a lower third, middle third and upper third, et cetera As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A liquid dietary composition for ruminants, the liquid dietary composition comprising:
a fatty acid component, wherein the fatty acid component comprises less than about 10% by weight of unsaturated fatty acid;
at least one feed ingredient selected from a carbohydrate, an amino acid, an amino acid derivative, a vitamin, a trace element, a mineral, a glucogenic precursor, or an antioxidant;
water present in an amount of about 25% to about 55% by weight of the liquid dietary composition; and
an emulsifier capable of emulsifying the liquid dietary composition.

2. The liquid dietary composition of claim 1, wherein the fatty acid component comprises at least one palmitic acid compound selected from the group consisting of free palmitic acid or a palmitic acid derivative selected from a palmitic acid ester, a palmitic acid amide, a palmitic acid salt, a palmitic acid carbonate, a palmitic acid carbamates, a palmitic acid imide and a palmitic acid anhydride.

3. (canceled)

4. The liquid dietary composition of claim 1, wherein the fatty acid component comprises a palmitic acid compound in an amount of at least about 60% by weight of the fatty acid component.

5.-6. (canceled)

7. The liquid dietary composition of claim 1, wherein the fatty acid component comprises an unsaturated trans fatty acid content in an amount of about 5% or less by weight of the fatty acid component.

8.-12. (canceled)

13. The liquid dietary composition of claim 1, wherein the fatty acid component is substantially free of unsaturated trans fatty acids.

14. (canceled)

15. The liquid dietary composition of claim 1, wherein the emulsifier has a hydrophilic-lipophilic balance value of about 5 to about 14.

16. The liquid dietary composition of claim 1, wherein the emulsifier comprises castor oil.

17. The liquid dietary composition of claim 1, wherein the emulsifier is present in the liquid dietary composition in an amount of about 0.01% by weight to about 1.0% by weight of the liquid dietary composition.

18. (canceled)

19. The liquid dietary composition of claim 1, wherein the fatty acid component comprises a saturated fatty acid content of at least about 90% by weight of the fatty acid component.

20.-23. (canceled)

24. The liquid dietary composition of claim 1, wherein the fatty acid component comprises about 30% or less free stearic acid by weight of the fatty acid component.

25. The liquid dietary composition of claim 1, wherein the fatty acid component is present in the liquid dietary composition in an amount of at least about 30% by weight of the liquid dietary composition.

26. (canceled)

27. The liquid dietary composition of claim 1, wherein the glucogenic precursor comprises at least one of glycerol, propylene glycol, molasses, propionate, glycerine, propane diol, or calcium propionate.

28. The liquid dietary composition of claim 1, wherein the vitamin is selected from vitamin A, vitamin B, vitamin D, or vitamin E.

29. (canceled)

30. The liquid dietary composition of claim 1, wherein the feed ingredient further comprises carnitine.

31. The liquid dietary composition of claim 1, wherein the amino acid leucine, lysine, histidine, valine, arginine, threonine, isoleucine, phenylalanine, methionine, tryptophan, or any derivative thereof.

32. The liquid dietary composition of claim 1, wherein the mineral is an ion of calcium, sodium, magnesium, potassium, phosphorus, zinc, selenium, manganese, iron, cobalt, copper, iodine, molybdenum, or a combination thereof.

33. The liquid dietary composition of claim 1, wherein the mineral comprises a salt selected from the group consisting of a sodium salt, a calcium salt, a magnesium salt, a cobalt salt, a manganese salt, a potassium salt, an iron salt and a zinc salt.

34.-40. (canceled)

41. The liquid dietary composition of claim 1, wherein the mineral comprises at least one of copper sulfate, copper oxide, selenium yeast, or at least one chelated mineral.

42. The liquid dietary composition of claim 1, wherein the feed ingredient further comprises at least one protein material selected from a grain or an oilseed meal.

43. (canceled)

44. The liquid dietary composition of claim 1, wherein the feed ingredient further comprises at least one cellulosic material.

45. (canceled)

46. The liquid dietary composition of claim 1, wherein at least a portion of the fatty acid component is encapsulated by a capsule.

47. (canceled)

48. The liquid dietary composition of claim 1, wherein at least a portion of the fatty acid component is contained by a plurality of micelles.

49.-50. (canceled)

51. The liquid dietary composition of claim 1, wherein at least a portion of the fatty acid component is contained within a core composition of a plurality of particles, and wherein a core material of the core composition comprises at least one of the protein material, the cellulosic material, the amino acid, and the amino acid derivative.

52. The liquid dietary composition of claim 1, wherein the liquid dietary composition is a non-solid, a liquid suspension, a slurry, a colloid, or an emulsion.

53. A method of preparing a liquid dietary composition for ruminants, the method comprising:
combining an emulsifier with a fatty acid component under pressurization to form an emulsion;
combining the emulsion, a feed ingredient and water to obtain the liquid dietary composition,
wherein the feed ingredient comprises at least one of a carbohydrate, an amino acid, an amino acid derivative, a vitamin, a trace element, a mineral, a glucogenic precursor, and an antioxidant.

54.-55. (canceled)

56. The method of claim 53, wherein the emulsifier is in an amount of about 0.01% by weight to about 1.0% by weight of the liquid dietary composition.

57.-58. (canceled)

59. The method of claim 53, wherein the fatty acid component comprises saturated fatty acid in an amount of at least about 90% by weight of the fatty acid component.

60.-62. (canceled)

63. The method of claim 53, wherein the vitamin is vitamin A, vitamin B, vitamin C, vitamin D, vitamin E, or a combination thereof.

64. The method of claim 53, wherein the amino acid is leucine, lysine,
histidine, valine, arginine, threonine, isoleucine, phenylalanine, methionine, tryptophan, any derivative thereof, or a combination thereof; and a mineral selected from the group consisting of calcium, sodium, magnesium, potassium, phosphorus, zinc, selenium, manganese, iron, cobalt, copper, iodine and molybdenum.

65. (canceled)

66. The method of claim 53, wherein the feed ingredient further comprises a protein material selected from a grain or an oilseed meal.

67.-74. (canceled)
